(19) United States
(12) Patent Application Publication
(10) Pub. No.: US 2011/0114100 A1
(43) Pub. Date: May 19, 2011

(54) P3 Personal Power and Performance Mouthpiece

(76) Inventors: Ramiro Michael Alvarez, Fremont, CA (US); Jose Sergio Alvarez, Newark, CA (US); Wayne Carl La Velle, Honolulu, HI (US)

(21) Appl. No.: 13/007,620

(22) Filed: Jan. 15, 2011

Related U.S. Application Data
(60) Provisional application No. 61/357,795, filed on Jun. 23, 2010.

(51) Int. Cl. A61C 5/14

(52) U.S. Cl. 128/861

(57) ABSTRACT

A dental mouthpiece clenched between the teeth and used to alleviate numerous dental and medical conditions as well as increase a user's performance. The mouthpiece improves facial tone and provides relief of temporomandibular joint pain and associated grinding of the teeth. The mouthpiece is less visible than prior art devices, even when the wearer opens his/her mouth, and does not cause discomfort. Furthermore, the mouthpiece allows for substantially unaffected speech, by the strategic placement of protuberances, so that the user may keep the mouthpiece in place and proceed about his or her business without providing any sound or visual cues to the presence of the mouthpiece.

### CROSS REFERENCE TO RELATED APPLICATION

This application claims the benefit of U.S. Provisional Application No. 61/357,795 filed on Jun. 23, 2010, entitled “P3 Personal Power and Performance Mouthpiece”

### BACKGROUND OF THE INVENTION

1. Field of the Invention

The present invention relates to an improvement in oral mouthpieces, more particularly, to an improved mouthpiece that alleviates numerous symptoms while increasing the user's performance and having a minimal impact on speech.

2. Description of the Prior Art

Athletics Application: As anyone familiar with sporting equipment or activities will be aware, mouth pieces for protecting the teeth of people engaged in active and contact sports are well known. Certainly boxers have been using mouth pieces for many years and as will be appreciated by those skilled in the art, football players universally use the mouth pieces during games or scrimmages. Examples of such protective mouth pieces are described in U.S. Pat. No. 3,124,129 issued to M. E. Grossberg, on Mar. 10, 1964, and U.S. Pat. No. 3,496,936 issued to K. W. Gores on Feb. 24, 1970. A closer review of these two patents, however, discloses that these appliances, or mouth pieces are generally bulky and have as a primary purpose protecting the teeth during physical activity or contact sports where impact forces may be received by the face or mouth area. However, as will also be appreciated by those skilled in the art, such mouth pieces are physically unattractive and prevent the user from speaking clearly and distinctly when in place. Therefore, as is well known, this type of mouth piece or protection device is continuously placed in the mouth and then removed during periods of non-contact. For example, the mouth piece is in place in the mouth of a boxer during each round but is removed in between rounds. Likewise for the football player, most mouth pieces are held in place only during the actual time the play is progressing and are not held in place during the huddle or between plays.

In addition to the well known mouth pieces or mouth protecting devices such as discussed above, which are for use by athletes during contact sports, it will be appreciated that recently it has been recognized that during periods of great tension the deleterious effect of such tension can be somewhat controlled by providing a device for an individual to clinch his teeth against. For example, U.S. Pat. No. 3,924,638 issued to G. E. Mann on Dec. 9, 1975, discloses two embodiments of such a tension relieving mouth appliance. Unfortunately, as was the case for the mouth pieces for contact sports and the like, these tension relieving mouth appliances are also readily visible when in place, and usually result in slurred or unclear speech by the wearer. Consequently, as would be expected, such devices cannot be worn all the time, and certainly cannot be worn by an individual under great stress at a formal meeting if the individual would be required to be very coherent, clear, emphatic, and precise in his speech. Thus, it will be appreciated that at the very time an individual under formal stress may most need an appliance, the prior art devices are not suitable for him to wear.

Almost all athletes clench their teeth during exertion which results in hundreds of pounds of compressed force exerted from the lower jaw onto the upper jaw. This clenching force is unevenly transmitted through the jaw structure into the connective tissues and muscles of the lower jaw and further into the neck and back. This can result in headaches, muscle spasms, damage to teeth, injury to the temporomandibular joint, and pain in the jaw. Furthermore, clenching the teeth makes breathing more difficult during physical exercise and endurance when breathing is most important.

Recent studies indicated that controlled stress of selected muscles, such as the masticator muscles in the jaw, have a desirable cumulative effect on an athlete or other individual in a competitive situation. That is, if particular selected muscles of the face can be brought to a selected tension or tonus, this tonus can affect other muscles of the body by increasing their tone and readiness for activity such that the athlete or wearer may achieve a competitive edge for a period of time.

Research has shown that the use of a mouthpiece, while in the awake state, can increase the mean minimal pharyngeal cross-sectional area by advancing the mandibular. The oropharynx and velopharynx areas can also be increased. The result leads to increased respiratory function and, consequently, increased oxygen intake. With an improvement in respiratory function, there may be a decreased need for oxygen delivery to the respiratory system, which leads to an increased supply to muscles and hence increased performance and slower fatigue rates. The mouthpiece of the present invention opens the throat in a three dimensional manner, without moving the jaw forward. The present invention accomplishes this by altering the tongue response by strategic placement of protuberances, which is a type of proprioceptive response.

Temporomandibular Disorders: Typically, localized occlusal interference splints [LOIS] for the mouth are appliances suited for persons who habitually clench their teeth or who are bruxists [clinical symptoms of Temporomandibular Disorders (TMD)]. These splints function by overloading the periodontal receptors of two teeth in an arch thereby reflexly reducing the muscle force generated by the person experiencing TMD.

A similar type of splint is an occlusal splint which also is a removable appliance that fits over the occlusal and incisal surfaces of the teeth in one arch creating precise occlusal contact with the teeth of the opposing arch. It is commonly referred to as a bite guard, night guard, interocclusal appliance, or orthopedic device. This type of splint typically can be used [1] to provide a more stable or functional joint position; [2] to introduce an optimum occlusal condition which reorganizes the neuromuscular reflex activity; or [3] to protect the teeth and supportive structures from abnormal forces which may create breakdown or tooth wear or both. [Okeson, “Fundamentals of Occlusion and Temporomandibular Disorders” (The C. V. Mosby Company, St. Louis, 1985), page 333]. Splint therapy has also been used for treatment of Temporomandibular Disorders [TMD].

Temporomandibular Joint Disorders [TMJ] can cause headaches, jaw clenching, and bruxism [side-to-side grinding of teeth]. Some headaches are related to problems with the temporal mandibular joint. It has been shown that a mouth-bite splint can be fashioned to prevent a person from clenching and realizing the various symptoms of TMJ and, in particular, soft bite guards which better absorb occlusal forces by virtue of their soft nature and aid in TMD and TMJ therapy [Lucia, “Modern Gnathological Concepts—Updated” (Quintessence Publishing Co., Inc., Chicago, 1983), page 38].

The Shore Mandibular Auto repositioning Appliance [SMAA] is another appliance which can aid in TMJ and TMD therapy. It was developed in approximately 1960. The SMAA frees the mandible from malocclusion and transmits the force of mandibular closure through the teeth to the maxilla thus removing pressures from the traumatized joints. In making the SMAA, a temporarily incorrect functional occlusion is created in acrylic. An acrylic-plate cast is made for the upper teeth, fitted to the person's teeth. An acrylic ramp [protuberance] approximately 3 mm thick is fabricated on the lingual aspect of the central incisors; Shore refers to the anti-occluder [protuberance] as a “ramp”]. The acrylic plate covers the palatal surface and the ramp acts as the splint [anti-occluder].

Sleep Disorders: Snoring, upper airway resistance syndrome, and obstructive sleep apnea syndrome (OSAS) are all related to narrowing or obstruction of the upper airway during sleep (sleep disordered breathing). Very common symptoms in OSAS patients are morning headaches and acid reflux. During airway obstructions the forceful attempts to inspire air can cause tremendous negative pressure in the chest. These high negative pressures can draw acid up the esophagus from the stomach. The acid can travel all the way into the mouth and cause inflammation of the vocal cords and nasal mucosa. The presence of the acid in the upper airway causes reflex bronchoconstriction in the lung that is similar to an asthma attack.

Snoring occurs when the mouth is open and the tongue moves back into the throat. This causes the airway passage to narrow which increases the likelihood of snoring. It is known that moving the condyle of the lower jaw forward in a way will increase the airway and assist in the elimination of snoring.

Nocturnal tooth grinding (bruxing) is a major pain—the pressure is ten times the force registered during normal chewing. Bruxing causes the teeth to wear down at odd angles, affecting the shape of the face, causing migraine headaches and muscle soreness and aggravating TMJ disorders.

Most importantly, sleep disorders can cause serious medical disorders and death. Apneas cause a large strain on the heart and lungs. Over time the many repeated episodes of apnea cause chronic changes leading to hypertension. Long periods of apnea allow the oxygen levels in the blood to decrease. In turn the low oxygen can cause heart attacks or strokes.

Use of a mouthpiece during sleep has been shown to substantially alleviate snoring, bruxing, acid reflux, as well as numerous other sleep disorders.

Weight: Research shows that use of a dental appliance to prevent damage to the teeth during clenching helps to increase the productivity of an aerobic workout by increasing endurance and muscle activity and therefore calorie burn.

Birthing: It is well known that the birthing process creates a tremendous amount of physiological and psychological stress upon the mother. In fact, pregnant women go through weeks, if not months, of physical exercise to prepare them for the exertions necessary during the birth of their child. The actual birthing process is very analogous to athletes as women about to give birth may very well clench their teeth during the exertion of labor.

Rehabilitation: Rehabilitation relative to heart attacks, operations and injuries also require exertion and can be facilitated by an increased blood flow to the brain and return back to good conditioning with exercise, which may be achieved by using a mouthpiece. Mouthpieces can also aid in recovery room therapy and when a patient is under general anesthesia.

Focus: It is believed that consciousness and the ability to focus is increased with an object in the mouth. This causes one to salivate, focus and be more awakened with improved concentration, hand eye coordination, and even thought process which otherwise would be non-voluntary reactions.

Breathing Improvements: Breathing with a mouthpiece improves the opening of the airway in a three dimensional size. Strategically placed protuberances, based on size and position, can stimulate the tongue with a guided pathway to achieve better tongue position. The result is less tongue obstruction in the airway, which creates less resistance. Analogously, the air capacity increases with each intake of air. The tongue further relaxes with each swallow of saliva.

While numerous oral appliances are known in the prior art today, none have proven to be fully effective as an everyday remedy. Major reasons for the lack of wider spread use, and hence increased effectiveness, for these appliances include the negative aesthetic appeal they carry and the impact they have on speech. The present invention offers a mouthpiece that, while learning numerous aspects from the prior art, alleviates these two major downfalls.

### SUMMARY OF THE INVENTION

In view of the foregoing disadvantages inherent in the known types of dental mouthpieces now present in the prior art, the present invention provides a new mouthpiece wherein the same can be utilized for providing convenience for the user by alleviating numerous medical conditions, improving performance, and providing unaltered speech.

It is therefore an object of the present invention to provide a dental mouthpiece that can alleviate numerous night time sleep disorders and excessive daytime sleepiness signs and symptoms, as described above.

Another object of the present invention is to provide a mouthpiece that can improve performance in athletes during daytime use.

Yet another object of the present invention is to provide a mouthpiece that can protect against teeth clenching in high stress situations (i.e. CPAP combination therapy).

Other objects, features and advantages of the present invention will become apparent from the following detailed description taken in conjunction with the accompanying drawings.

### BRIEF DESCRIPTIONS OF THE DRAWINGS

FIG. 1 Shows a top view of the upper mouthpiece.

FIG. 2 Shows a side view of the upper mouthpiece fitted around upper teeth.

FIG. 3 Shows a cross section cut of the upper mouthpiece.

FIG. 4 Shows a top view of the lower mouthpiece fitted around lower teeth.

FIG. 5 Shows a facial side view of the lower mouthpiece fitted over teeth.

FIG. 6 Shows a lingual side view of the lower mouthpiece.

FIG. 7 Shows a cross sectional back view of the bite section on the lower mouthpiece.

### DETAILED DESCRIPTION OF THE INVENTION

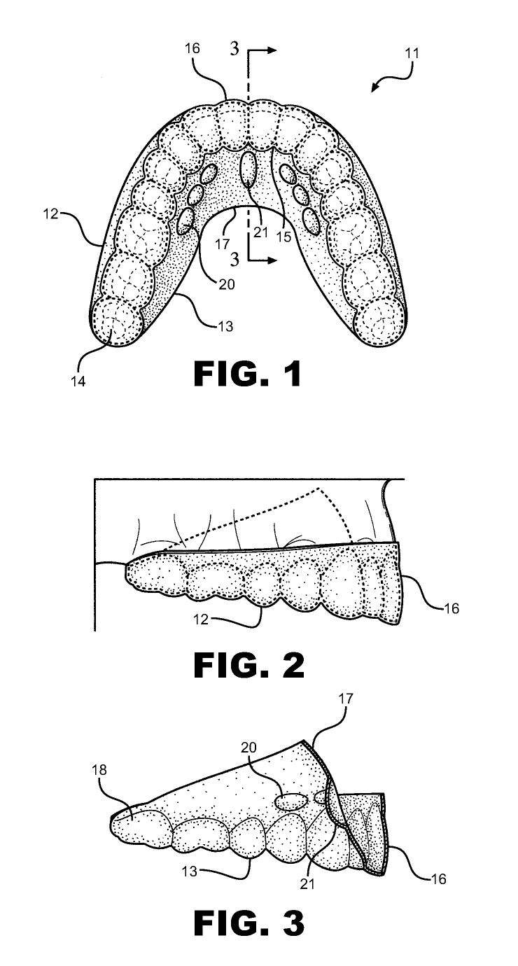

Referring now to FIG. 1, there is shown a top view of the upper mouthpiece 11. The upper mouthpiece 11 is a single piece appliance made of soft resilient material. The area of the mouthpiece located in the forwarded most region of the mouth is denoted as the anterior surface. The anterior surface comprises lingual 15 and facial surfaces 16. The left and right sides and back of the mouthpiece are denoted as the posterior surface. The posterior surface comprises facial 12, lingual 13, and occlusal 14 surfaces.

Protuberances 20, 21 are strategically positioned on the lingual surfaces 15, 13 of the mouthpiece to increase tongue interaction and tongue response. An incisor protuberance 21 is located on the lingual side between the two incisors. The incisor protuberance 21 is oblong and extends from the gum line to the hard palate region 17 of the mouth.

Three smaller, rounder protuberances 20 are located on the lingual surfaces 13 of the posterior left and right sides. The protuberances 20 are each located near the gum line, with a first protuberance located at a cuspid tooth, a second protuberance located at a first bicuspid tooth, and a third protuberance located at a second bicuspid tooth.

Each of the protuberances 20, 21 may protrude into the mouth from 1 mm to 5 mm, generally, depending on the tongue response and performance of the individual wearing the mouthpiece. Additionally, the three posterior protuberances 20 may be tuned to a specific individual and may therefore vary in size and shape relative to each other or be of substantially the same size and shape. Tuning may include increasing or decreasing the diameter of a single protuberance as well as increasing or decreasing the general roundness of a single protuberance.

FIGS. 2 and 3 illustrates how the lingual surface 13 of the mouthpiece extends down to the gum line of the molar 18. From the molar 18 to the incisors, the lingual surface gradually slopes past the gum line to cover the hard palate 17 of the mouth. FIG. 2 illustrates the facial surfaces 12, 16 stopping at the gum line.

FIG. 3 shows a cross sectional view through the incisal protuberance 21. The protuberance 21 can be seen protruding into the user's mouth and extending from the gum line to the hard palate. The facial surfaces 12, 16 of the mouthpiece stops at the gum line, wherein the lingual surfaces taper from the gum line in the most posterior region (molars) 18 of the mouth to the hard palate 17 at the anterior region of the mouth.

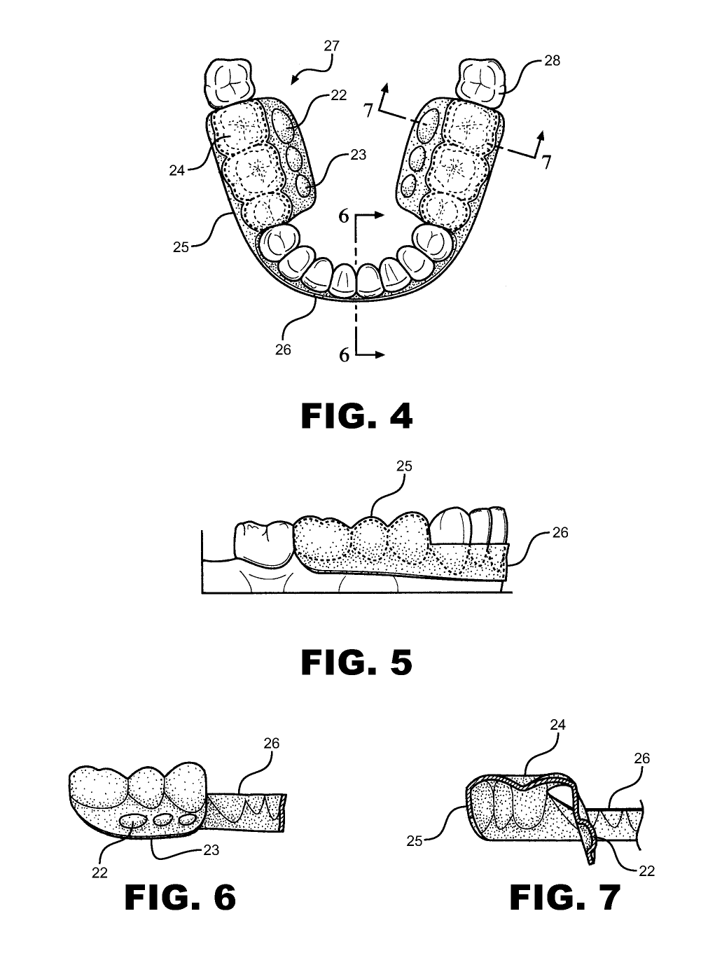

FIG. 4 shows a top view of the lower mouthpiece 27. The lower mouthpiece 27 is a single piece appliance made of soft resilient material. The mouthpiece extends to, but does not cover, the third molar 28. The mouthpiece has a bite section that covers the second molar, first molar, and second premolar on the left and right sides of the mouth. Each bite section has a facial surface 25, a lingual surface 23 and an occlusal surface 24, wherein the three surfaces form a trough covering these three teeth. The facial surface 25, 26 extends the entire mouthpiece, reaching down to the gum line at each tooth. The anterior facial surface 26 only covers the gum line area of the teeth in order to be discrete and to enhance speech. FIG. 5 shows how the anterior surface 26 covers only the gum line area of a user's mouth. FIG. 4 and FIG. 6 show how the lingual 23 and occlusal 24 surfaces are only present at the bite section of the mouthpiece.

A plurality of protuberances 22 are formed to increase tongue interaction and tongue response. A protuberance is located on the lingual surface at the gum line of the first molar, second molar, and second premolar. FIG. 7 depicts a cross sectional view of the left side, looking forward, wherein a protuberance 22 at the second molar is shown. The lingual surface 23 extends to the gum line plus the diameter of a protuberance 22. These three protuberances 22 can be of substantially the same diameter and shape, or may vary with respect to each other as well as with respect to the protuberances 20, 21 on the upper mouthpiece. The protuberances 22 can be sized larger in diameter or more oblong, depending on the specific patient's tongue response.

In use an individual will simply insert the mouthpieces into their mouth and push them against the teeth. The top and bottom mouthpieces are suitable to be worn individually or at the same time. However, it is believed that symptoms can be substantially alleviated with the use of either mouthpiece alone. The bottom mouthpiece is especially suitable to be worn alone, as it's far more discrete than the upper mouthpiece, which may be beneficial when appearance is important.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A soft resilient performance increasing and therapeutic mouthpiece for removably attaching to the upper teeth of a user, comprising;
facial and lingual anterior surfaces, facial and lingual posterior surfaces, and an occlusal surface, wherein said surfaces are connected to form a trough, said trough being molded to conform to a user's teeth;
said lingual anterior surface having an incisor protuberance projecting into a user's mouth for increasing tongue interaction and tongue response, wherein said protuberance is located between a pair of central incisors;
a plurality of protuberances located on said lingual posterior surfaces, wherein a first protuberance is located at a cuspid tooth, a second protuberance is located at a first bicuspid tooth, and a third protuberance is located at a second bicuspid tooth;
said facial posterior surfaces and said facial anterior surfaces extending down to a gum line of a user;
said lingual posterior surfaces and said lingual anterior surface extending into said user's mouth to substantially cover a hard palate of said user.

2) A soft resilient performance increasing and therapeutic mouthpiece for removably attaching to the lower teeth of a user, comprising;
bite sections forming left and right sides, said bite sections having a lingual surface, a facial surface, and an occlusal surface that form a trough for covering a second molar, a first molar and a second premolar of a user's mouth;
a plurality of protuberances located at a gum line on said lingual surface of said bite sections, wherein a first protuberance is located at said first molar, a second protuberance is located at said second molar, and a third protuberance is located at said first premolar.

3) The mouthpiece of claim 2, wherein said left and right bite sections are connected by an anterior facial surface, said anterior facial surface extending across a facial side of a user's teeth and covering said gum line of said user's mouth.

4) A performance increasing and therapeutic mouthpiece for removably attaching to the teeth of a user, comprising;
facial and lingual anterior surfaces, facial and lingual posterior surfaces, and an occlusal surface, wherein said surfaces are connected to form a trough, said trough being molded to conform to a user's teeth; wherein a plurality of protuberances are located on said lingual anterior, lingual posterior, or occlusal surface.
